(19) United States
(12) Patent Application Publication
(10) Pub. No.: US 2010/0198741 A1
(43) Pub. Date: Aug. 5, 2010

(54) DESIGNATING PRIORITY FOR CHARACTERISTICS OF VITALITY EVENTS IN A SOCIAL NETWORKING SYSTEM

(75) Inventors: Steven Horowitz, Oakland, CA (US); William MacDonald White, Sausalito, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/363,447

(22) Filed: Jan. 30, 2009

(51) Int. Cl. G06Q 99/00

(52) U.S. Cl. 705/319

(57) ABSTRACT

A social networking system is configured to enable users in the system to prioritize vitality events in their respective vitality streams. For instance, a user may designate that at least one specified prioritization action is to be performed for any vitality event having one or more characteristic(s) specified by the user. Accordingly, when a vitality event having the one or more specified characteristic(s) is associated with the user, the at least one specified prioritization action is performed with respect to that vitality event.

### BACKGROUND OF THE INVENTION

1. Field of the Invention

The present invention generally relates to social networking. In particular, the present invention is related to prioritizing vitality events in a social networking system.

2. Background Art

Vitality streams are a central feature of social networking systems, including social networks and “socialized” portal web sites, such as those hosted by Yahoo!, Microsoft, and Google. Facebook®, MySpace®, and Linkedln® are some examples of social networks. Example socialized portal web sites include www.flickr.com, movies.yahoo.com, videos.yahoo.com, zone.msn.com, music.msn.com, www.youtube.com, etc. A variety of different terms are used interchangeably to refer to vitality streams. For example, vitality is commonly referred to as “activity”, “event”, “status”, or “news”, and streams are commonly referred to as “feeds”, “updates”, or “alerts”.

A vitality stream is essentially a list of vitality events, which are generated in response to interactions of users who belong to a given affinity set. A user's interactions may be with content or another one or more members of the affinity set.

For example, an affinity set may be any group of persons, including a group of friends, business associates, players of a massively multiplayer online game, persons with a common interest, all users of a social network, application (“app”), or web site, or a subgroup thereof. Social networking systems typically display vitality streams on respective users' profile or home pages, which are often displayed to the users as web pages using a web browser. Although vitality events are often directly associated with native social networking functions or portal web page consumption, embedded social applications installed by users may generate vitality events, as well.

Each interaction by a user causes a corresponding vitality event to be generated. Within social application “canvas” (a.k.a. “app,” “large”) views, vitality events may be limited to interactions among users of a particular social application.

A social application is a supplementary utility, game, etc. made available by the social network platform or a third-party to run on the social network. Example social applications include Facebook®'s “Wall”, various slideshows, iLike®, RockYou's “GlitterText,” Slide Inc.'s “SuperPoke!®,” Hasbro's “Scrabble®” for Facebook®, etc. For portal site subdomain views, vitality events may be limited to interactions among users of a particular subdomain (e.g., news.yahoo.com), though the view may also include events generated by embedded social applications installed by the user on that subdomain.

In conventional social networking systems, each generated vitality event is added to the user's vitality stream and/or to the vitality streams of other users who belong to an affinity set of the user in near-real-time without taking into account preferences of the respective users regarding prioritization of the vitality events. Moreover, while the vitality streams may be filtered by affinity set member or by type, for example, conventional social networking systems do not support archiving or searching of vitality events due to the cost associated with storage of the vitality events and their ephemeral urgency.

Vitality streams are becoming torrential due to the growth of social functionality in social networking systems, the proliferation of first-party and third-party social applications available to users, and the expanding numbers of “friends” in social directories. Conflicting with this trend, conventional social networking systems limit the number of vitality events in each vitality stream. For instance, vitality streams are typically implemented as first-in-first-out (FIFO) lists, meaning that only the most recent <n> events are stored and displayed. Thus, whenever users access a conventional social networking system, the users can see only the most recent snapshot of their or other users' interactions. Consequently, many vitality events of interest already may have been removed from a user's vitality stream before the user has a chance to view them.

### BRIEF SUMMARY OF THE INVENTION

Systems, methods, and computer program products are described herein for prioritizing vitality events in a social networking system. Embodiments of the present invention enable users in the social networking system to prioritize vitality events in their respective vitality streams. For instance, a user may designate that at least one specified prioritization action is to be performed for any vitality event having one or more characteristic(s) specified by the user. Accordingly, when a vitality event having the one or more specified characteristic(s) is associated with the user, the at least one specified prioritization action is performed with respect to that vitality event.

By enabling prioritization of vitality events in a user's vitality stream, embodiments of the present invention can advantageously enable the user to not display specified vitality events in the user's vitality stream, emphasize specified vitality events in the user's vitality stream, archive specified vitality events, and/or have a message (e.g., email, IM, SMS, etc.) sent to the user when a specified vitality event is received. If the user chooses to archive a vitality event, the vitality event may be accessed at any time at the leisure of the user. If the user chooses to receive a message upon receipt of a vitality event, the user need not necessarily wait to see the vitality event fortuitously upon logging into the social networking system In particular, a first method is described in which a menu or other graphical interface element is provided on a social networking web page that enables a user to select one or more characteristics of a first vitality event in a vitality stream of the user. The menu further enables the user to select at least one prioritization action with respect to vitality events having the one or more characteristics. The menu may be provided in response to receiving a command regarding the first vitality event from the user. An indication that the selected one or more characteristics correspond to the selected at least one prioritization action is stored.

A second method is described in which a plurality of weights associated with a plurality of respective characteristics of a vitality event in a vitality stream of a user are increased or decreased. The plurality of weights may be increased or decreased in response to receiving a command from the user. The plurality of weights are compared to respective thresholds. A determination is made that a weight of a first characteristic of the plurality of characteristics reaches a corresponding first threshold. In response to the determination, an inquiry is provided on a social networking web page that enables the user to select at least one prioritization action to be performed with respect to vitality events having the first characteristic.

A third method is described in which a first at least one characteristic of a vitality event is compared to a second at least one characteristic corresponding to one or more user-specified prioritization actions for prioritizing vitality events in a vitality stream of a user. The one or more user-specified prioritization actions are performed with respect to the vitality event in response to the first at least one characteristic matching the second at least one characteristic.

Computer program products are also described herein. A first computer program product includes a computer-readable medium having computer program logic recorded thereon for enabling a processor-based system to prioritize vitality events in a social networking computer system. The computer program logic includes first, second, and third program logic modules. The first program logic module is for increasing or decreasing a plurality of weights associated with a plurality of respective characteristics of a vitality event in a vitality stream of a user in response to receiving a command from the user. The second program logic module is for comparing the plurality of weights to respective thresholds to determine that a weight of a first characteristic of the plurality of characteristics reaches a corresponding first threshold. The third program logic module is for providing an inquiry on a social networking web page that enables the user to select at least one prioritization action to be performed with respect to vitality events having the first characteristic in response to the weight of the first characteristic reaching the corresponding first threshold.

A second computer program product includes a computer-readable medium having computer program logic recorded thereon for enabling a processor-based system to prioritize vitality events in a social networking computer system. The computer program logic includes a first program logic module and a second program logic module. The first program logic module is for enabling the processor-based system to compare a first at least one characteristic of a vitality event and a second at least one characteristic corresponding to one or more user-specified prioritization actions for prioritizing vitality events in a vitality stream of the user. The second program logic module is for enabling the processor-based system to perform the one or more user-specified prioritization actions with respect to the vitality event in response to the first at least one characteristic matching the second at least one characteristic.

Systems are also described herein. A first system includes a weight change module, a comparison module, and an inquiry module. The weight change module is configured to increase or decrease a plurality of weights associated with a plurality of respective characteristics of a vitality event in a vitality stream of a user in response to receiving a command from the user. The comparison module is configured to compare the plurality of weights to respective thresholds to determine that a weight of a first characteristic of the plurality of characteristics reaches a corresponding first threshold. The inquiry module is configured to provide an inquiry on a social networking web page that enables the user to select at least one prioritization action to be performed with respect to vitality events having the first characteristic in response to the weight of the first characteristic reaching the corresponding first threshold.

A second system includes a comparison module and a prioritization action module. The comparison module is configured to compare a first at least one characteristic of a vitality event and a second at least one characteristic corresponding to one or more user-specified prioritization actions for prioritizing vitality events in a vitality stream of the user. The prioritization action module is configured to perform the one or more user-specified prioritization actions with respect to the vitality event based on the first at least one characteristic matching the second at least one characteristic.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example social networking system according to an embodiment of the present invention.

FIG. 2 is an illustration of an example web page showing a vitality stream of a corresponding user in accordance with an embodiment of the present invention.

FIG. 3 is an illustration of an example web page showing a graphical interface element for characterizing a vitality event in accordance with an embodiment of the present invention.

FIG. 4 shows a flowchart of a method for characterizing a vitality event in accordance with an example embodiment of the present invention.

FIG. 5 is an example implementation of the priority designation module shown in FIG. 1, according to an embodiment of the present invention.

FIG. 6 is an example implementation of the storage shown in FIG. 5, according to an embodiment of the present invention.

FIGS. 7-8 are illustrations of example web pages showing respective inquiries for characterizing a vitality event in accordance with an embodiment of the present invention.

FIG. 9 is an illustration of an example web page showing an inquiry for designating a prioritization action as a result of the weight of a vitality event characteristic reaching a lower threshold, according to an embodiment of the present invention.

FIG. 10 is an illustration of an example web page showing an inquiry for designating a prioritization action as a result of the weight of a vitality event characteristic reaching an upper threshold, according to an embodiment of the present invention.

FIGS. 11-12 are illustrations of example web pages that enable a user to deselect a priority designation, according to embodiments of the present invention.

FIG. 13 shows a flowchart of a method for characterizing a vitality event in accordance with another example embodiment of the present invention.

FIG. 14 is another example implementation of the priority designation module shown in FIG. 1, according to an embodiment of the present invention.

FIG. 15 shows a flowchart of a method for performing prioritization action(s) in accordance with an example embodiment of the present invention.

FIG. 16 is an example implementation of the priority performance module shown in FIG. 1, according to an embodiment of the present invention.

FIG. 17 is a block diagram of an example computer system that may be used to implement one or more aspects of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### II. Example Social Networking System

Embodiments of the present invention enable users in a social networking system to prioritize vitality events in their respective vitality streams. For instance, a user may designate that at least one specified prioritization action is to be performed for any vitality event having one or more characteristic(s) specified by the user. Accordingly, when a vitality event having the one or more specified characteristic(s) is associated with the user, the at least one specified prioritization action is performed with respect to that vitality event.

A vitality event characteristic may be defined to include a value for any component (i.e., item) of the vitality event or for a particular item of the vitality event, or information derived from metadata or a tag associated with the vitality event. A more detailed discussion of vitality event characteristics and some examples thereof are provided in section III. Example prioritization actions include but are not limited to not displaying the vitality event in the user's vitality stream, emphasizing the vitality event in the user's vitality stream, sending a message to the user indicating receipt of the vitality event, etc. Further description of these and other example prioritization actions is provided in the following sections.

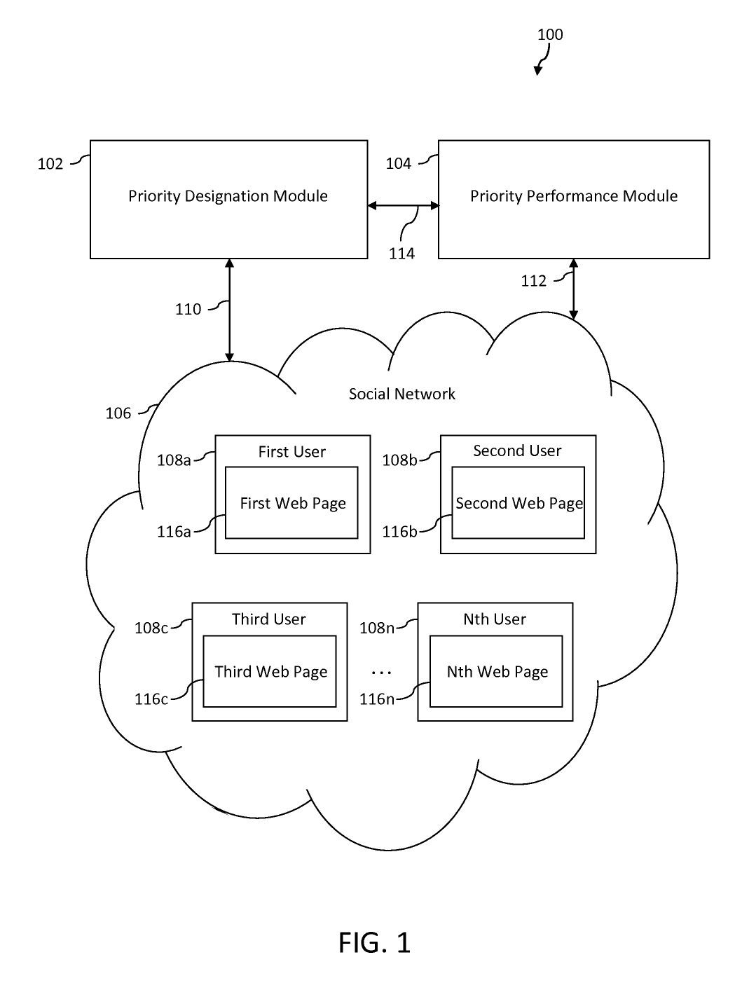

FIG. 1 shows a block diagram of an example social networking system 100, according to an embodiment of the present invention. As shown in FIG. 1, social networking system 100 includes a priority designation module 102, a priority performance module 104, and a social network 106. Social network 106 is communicatively connected to priority designation module 102 and priority performance module 104 by respective first and second communication interfaces 110 and 112. Priority designation module 102 and priority performance module 104 are communicatively connected by a third communication interface 114. Priority designation module 102, priority performance module 104, and social network 106 communicate with one another in accordance with well-known network communication protocols. Each of the elements of system 100 is described in detail below. Further description of the elements of system 100 is provided in subsequent sections.

Social network 106 is an online social network or a combination of social networks, that includes a community of users 108 (network participating persons). First-nth users 108a-108n are shown in social network 106 in FIG. 1. Social network 106 may include any number of users 108, including hundreds, thousands, or even millions of users 108. Users 108 may interact with each other in social network 106 using corresponding electronic devices (e.g., computers, cell phones, personal digital assistants (PDAs), etc.), as described in detail further below. Social network 106 operates within a communication network, such as a local area network (LAN), a wide area network (WAN), or a combination of networks, such as the Internet. For example, social network 106 may be based in the World Wide Web. The communication network enables communication between users 108. Social network 106 may enable one or more ways for users to interact, including enabling communications between users 108 through one or more of blogging, discussion groups, email, file sharing, instant messaging, online chat, video, voice chat, and/or other user communication mechanisms.

When a user 108 interacts with an application, content or another user in social network 106, a vitality event is generated by social network 106 to memorialize and/or summarize the interaction. Social network 106 associates the vitality event with the user 108 and/or other users in an affinity set of the user 108. Social network 106 provides the vitality event to priority performance module 104 via second communication interface 112. Priority designation module 102 and priority performance module 104 collaborate to enable prioritization of the vitality event with respect to each user with whom the vitality event is associated based on priority designations of the respective users.

Priority designation module 102 enables each user to make priority designations pertaining to future vitality events associated with the user based on characteristics of vitality events currently in the user's vitality stream. For instance, a user 108 may designate that vitality events associated with the user 108 that have a specified characteristic or combination of characteristics corresponding to a vitality event in the user's vitality stream are to be prioritized in accordance with at least one specified prioritization action. Priority designation module 102 stores each such priority designation in prioritization information associated with the user 108.

Priority performance module 104 accesses priority designation module 102 via third communication interface 114 upon receiving a vitality event from social network 106 to obtain the prioritization information, including any priority designations, of each user associated with the vitality event. Priority performance module 104 reviews the priority designations for each user associated with the vitality event to determine whether a user-specified prioritization action is to be performed with respect to the vitality event. For each associated user, priority performance module 104 compares one or more characteristics of the vitality event to one or more user-specified characteristics corresponding to at least one user-specified prioritization action in the user's prioritization information to determine whether the specified prioritization action is to be performed with respect to the vitality event.

If the one or more characteristics of the vitality event matches the one or more user-specified characteristics corresponding to the at least one user-specified prioritization action, priority performance module 104 performs the prioritization action with respect to the vitality event. Otherwise, priority performance module 104 delivers the vitality event to the vitality stream of the user in accordance with a default setting.

Vitality events that are delivered to the vitality stream of the user 108, whether in accordance with a prioritization action or a default setting, may be added to the vitality stream of the user 108 in chronological or other order. The vitality stream of the user 108 may be displayed as a respective web page 116 or in other form.

In one aspect, priority designation module 102 is configured to send an inquiry to a user 108 via first interface 110, enabling the user 108 to establish a relationship between vitality event characteristic(s) and prioritization action(s). The inquiry may be displayed to the user 108 in a respective web page 116 or in other form. The inquiry may be sent to the user 108 in response to the user 108 sending a command to priority designation module 102, though the scope of the embodiments is not limited in this respect.

Priority designation module 102 may store other personal information about the respective users 108, in addition to their prioritization information. Such information may include any information that the users 108 desire to make accessible to other users of social network 106, though the scope of the embodiments is not limited in this respect. For example, the personal information about a user may include a name and/or an alias, a representative image (e.g., a photographic image and/or avatar), contact information, status information, a list of interests, and/or other information regarding the respective user 108. The personal information may be configured to support a self-description page (also referred to as a “user profile page”) for the user, which may be displayed as a web page or in other form. In one aspect, the personal information may include a list of one or more affinity sets to which the respective user 108 belongs and/or a list of members for each affinity set. For instance, first user 108a may include users 108b and 108c in a friends list maintained in the personal information of first user 108a. The information may also include demographic or psychographic information regarding the users 108, a list of user-installed social network applications, user preferences, options, settings, the users' respective click streams, etc.

Social networking system 100 is shown in FIG. 1 to include a single social network 106 for illustrative purposes and is not intended to be limiting. Persons skilled in the relevant art(s) will recognize that social networking system 100 may include any one or more social network(s) and/or socialized portal web sites.

Social networking system 100 may be described as having client-side processes and server-side processes. The client-side processes are performed by a computer application, such as a web browser, that runs on an electronic device of a user. The server-side processes, on the other hand, are performed by a computer program, such as a web server, that runs on a remote server of a vitality service, for example. The techniques described herein may be performed using client-side processes, server-side processes, or a combination thereof For client-side processes, the user's electronic device fetches priority designations of the user and applies them in a browser using any suitable programming language, such as JavaScript or Flash. For server-side processes, the remote server of the vitality service may make internal calls to a user database using application programming interfaces (APIs), for example, to access a user's priority designations and to prioritize the vitality events on the server. The remote server may utilize any suitable programming language, such as PHP, C++, etc. The remote server pushes the prioritized vitality events to the user in accordance with the user's priority designations.

### III. Vitality Events

A vitality event may be represented in any of a variety of formats. One such format is <source><event>, where the value of the <source> is determined from a source tag associated with the vitality event, and the <event> is the vitality event itself. The <source> identifies the user, web domain, web sub-domain, or application in social network 106 that generates the vitality event. The <event> includes any number of items to summarize a user interaction. The items of the <event> may be arranged in accordance with a designated syntax, though the scope of the embodiments is not limited in this respect. Examples of such items include but are not limited to a <user1> item specifying a subject user, an <action> item specifying an action performed by the subject user, an <object> item specifying an object upon which the subject user performs the action, a <user2> item specifying a non-subject user (e.g., a recipient of the action), and an <attribute> item further describing the action.

Following are four example syntaxes for the <event> portion of the above-described vitality event format:

(1) <user1><action><object>(<attribute>)

(2) <user1><action><user2>

(3) <user1><action><object><preposition><user2>

(4) <user1><action>(<preposition>) <user2>'s <object>

These example syntaxes are provided for illustrative purposes and are not intended to limit the scope of the embodiments. Persons skilled in the relevant art(s) will recognize that items in a vitality event may be arranged in accordance with a syntax other than those set forth above or in the absence of an established syntax.

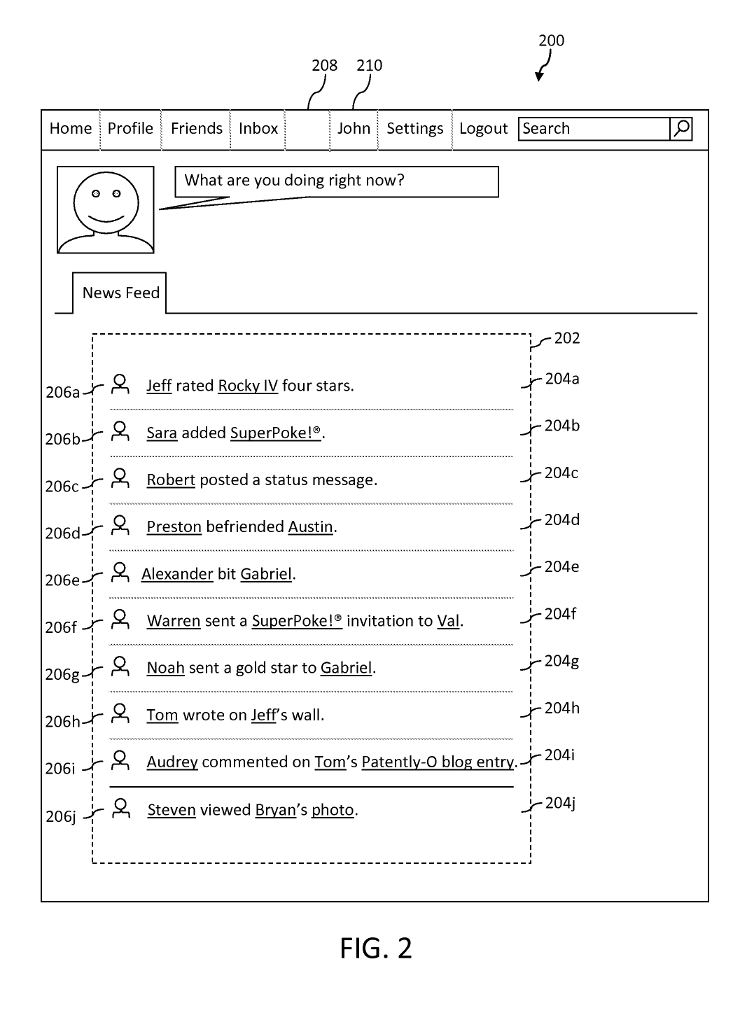

FIG. 2 is an illustration 200 of an example web page showing a vitality stream 202 of a corresponding user 108 in accordance with an embodiment of the present invention. As shown in FIG. 2, vitality stream 202 corresponds to a user 108 named John, as indicated in name block 210 of header 208. Vitality stream 202 includes a plurality of vitality events 204a-204j indicating the interactions of other users in John's affinity set (e.g., his friends). Persons skilled in the relevant art(s) will recognize that vitality stream 202 may include vitality events indicating the interactions of John, as well, or instead.

Vitality events 206a-206c are arranged in accordance with example syntax (1) as described above, such that <user1> performs an <action> upon an <object>. The <attribute> item is optional. In vitality event 206a, the <user1> is “Jeff”, the <action> is “rated”, the <object> is a link to the movie “Rocky IV”, and the <attribute> is “four stars”. <User> items are linked to social network profile pages of respective users. <Object> items may or may not be linked to a web page containing content (text, images, etc.) associated with the respective objects.

Thus, it can be said that one characteristic of vitality event 206a is: <user1>=Jeff. Other characteristics of vitality event 206a are: <action>=rated, <object>=<link to “Rocky IV”>, and <attribute>=four stars. In an aspect, priority designation module 102 may not differentiate between the <user1> and <user2> items of a vitality event. For example, priority designation module 102 may treat the <user1> and <user2> items as the same type of item. Accordingly, a characteristic of vitality event 206a may be that “Jeff” is the value of a <user1> or <user2> item. In another aspect, a characteristic of vitality event 206a may be that at least one item in vitality event 206a has the value “Jeff”. Any information included in metadata or a tag associated with vitality event 206a may be a characteristic, as well. For example, vitality event 206a may be associated with a source tag, indicating that the source of vitality event 206a is the Yahoo! Movies web site (i.e., movies.yahoo.com). In this example, <source>=movies.yahoo.com is another characteristic of vitality event 206a.

The <object> item of vitality event 206a is shown to be a link to a web page containing content associated with the movie “Rocky IV”. Priority designation module 102, besides distinguishing between specific links, may also distinguish between categories of links. For example, a characteristic of vitality event 206a may be that the <object> item is a movie link, without regard to the particular movie. If John clicks the link to “Rocky IV”, the link may direct him to the corresponding web page on the Yahoo! Movies web site or another web site from which he may order or purchase the movie “Rocky IV”, see clips from the movie, read information about the movie, its characters, actors, etc.

In vitality event 206b, the <user1> is “Sara”, the <action> is “added”, the <object> is a link to the social application “SuperPoke!®”, and no <attribute> is specified. The link in vitality event 206b may direct the user to the description or installation page for SuperPoke!® if the user has not installed SuperPoke!® or to the user's homepage on the SuperPoke!® application if the user has already installed SuperPoke!®. In an embodiment, priority designation module 102 may not differentiate between different social applications. For example, a characteristic of vitality event 206b may be that the object is a link to any social application, without regard to any particular social application.

In vitality event 206c, the <user1> is “Robert”, the <action> is “posted”, the <object> is “status message”, and no <attribute> is specified.

Vitality events 206d-206e are arranged in accordance with example syntax (2), such that <user1> performs an <action> upon <user2>. It should be noted that the <action> for any syntax may be an actual or a virtual action. For example, vitality event 206e states that Alexander bit Gabriel. The <action> “bit” may be a virtual action that is selected or created by <user1> (i.e., Alexander in this example). Vitality events 206f-206g are arranged in accordance with example syntax (3), such that <user1> performs an <action> upon an <object> with respect to <user2>. It should be noted that the <object> for any syntax may be a real or virtual object. In vitality event 206g, the <user1> is “Noah”, the <action> is “sent”, the <object> is “gold star”, the <preposition> is “to”, and the <user2> is “Gabriel”. The <object> “gold star” may be a virtual object selected or created by <user1>.

Vitality events 206h-206j are arranged in accordance with example syntax (4).

The <object> of vitality event 206h is a link to Jeff's wall, which is a webpage that chronicles Jeff's interactions and that allows users in Jeff's affinity set to post statements or other information. The object in vitality event 206i is a link to Tom's entry on the Patently-O blog web site. If John clicks the link in vitality event 206i, the link may direct him to the Patently-O blog homepage or directly to Tom's entry. The object in vitality event 206j is a link to a specific photo associated with Bryan's profile. In vitality events 206h-206i, the optional <preposition> is “on,” whereas in vitality event 206j, the optional <preposition> is not specified.

Each vitality event 204 in vitality stream 202 corresponds to a respective icon 206, which may be used for purposes of prioritizing vitality events having one or more characteristics of the corresponding vitality event 204. Icons 206 may be visible at all times or only when the cursor is placed over them. For example, the user 108 may cause an icon 206 to appear by hovering the cursor in the vicinity of the icon 206. The user 108 may select (e.g., click on) an icon 206 to display a menu, such as a pop-up, drop-down, or equivalent menu, or other graphical interface element to enable the user 108 to establish relationship(s) between characteristic(s) of the vitality event 204 and prioritization action(s). Although depicted as the “head and shoulders” of a human in FIG. 2, icons 206 may have any other suitable form.

### IV. Example Priority Designation Embodiments

Example embodiments are described in this section for establishing priority designations for characteristics of vitality events. A priority designation represents a relationship between one or more characteristics and at least one prioritization action to be performed with respect to each vitality event having the one or more characteristics. Embodiments are described for enabling a user to establish a relationship between characteristic(s) of a vitality event in the user's vitality stream and prioritization action(s) regarding disposition of vitality events having the characteristic(s). The example embodiments described herein are provided for illustrative purposes, and are not limiting. Further structural and operational embodiments, including modifications/alterations, will become apparent to persons skilled in the relevant art(s) from the teachings herein.

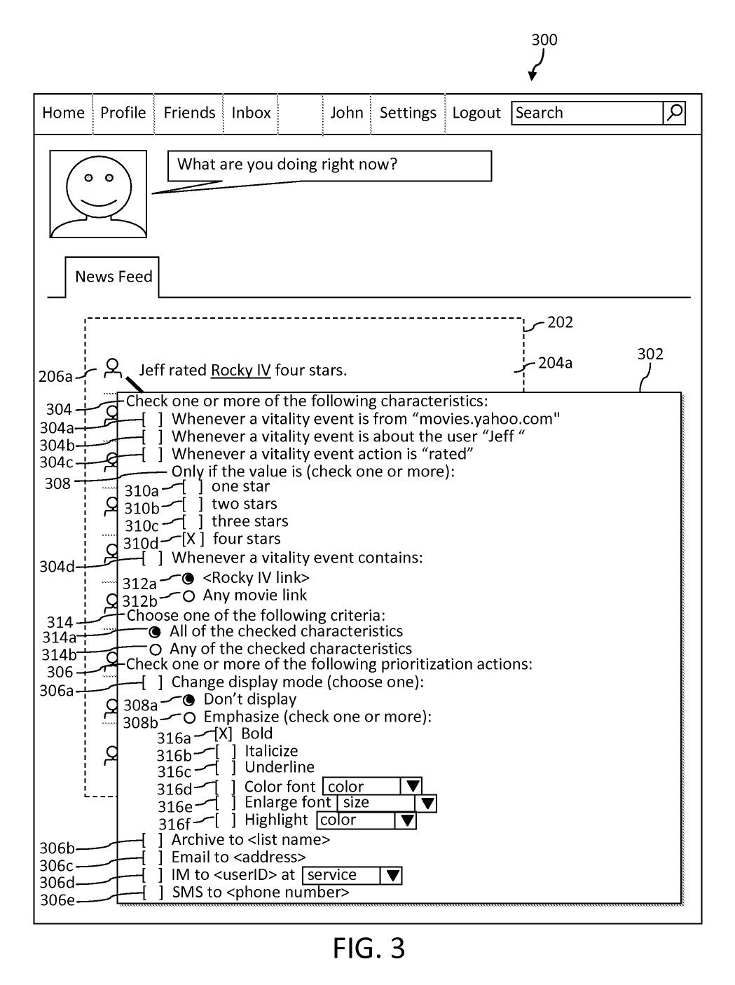

FIG. 3 is an illustration 300 of an example web page showing a graphical interface element 302 for characterizing a vitality event in accordance with an embodiment of the present invention. In particular, graphical interface element 302 enables a user 108 to characterize a vitality event in the user's vitality stream 202 by establishing a relationship between characteristic(s) of the vitality event and at least one prioritization action. As shown in FIG. 3, the user 108, John, selects icon 206a to cause graphical interface element 302 to be displayed in the web page. For example, priority designation module 102 may generate graphical interface element 302 in response to the user 108 selecting icon 206a.

Menu 302 lists characteristics 304a-304d of vitality event 204a, which corresponds to icon 206a, and a variety of prioritization actions 306a-306f. The user 108 may specify any one or more of the listed characteristics 304 by checking the box to the left of each respective characteristic. Characteristic 304a indicates that a checked prioritization action is to be performed whenever a vitality event is from the source movies.yahoo.com. It is presumed in this example that vitality event 204a is from the source movies.yahoo.com for purposes of illustration, though it will be recognized that vitality event 204a may be from any suitable source. Characteristic 304b indicates that a checked prioritization action is to be performed whenever a vitality event is about the social network member 108 designated by “Jeff”. Vitality events such as 204a link member names to corresponding member profile pages. Setting the characteristic to the corresponding link URL or member user ID serves to disambiguate among all members named “Jeff.” In general, “Jeff” may correspond to a <user1> item or a <user2> item of a vitality event, though the scope of the embodiments is not limited in this respect.

It should be noted that characteristic 304b may contain a drop-down (or equivalent) menu to enable the user 108 to select among any of the members in an affinity set of the user, for example, or even users that are not members of an affinity set of the user. For instance, the user 108 may be able to specify not only Jeff, but any member of the user's affinity set or any user referenced in a vitality event received by the user (e.g., in a <user2> item thereof). It will be recognized that such users need not necessarily belong to an affinity set of the user. Such a menu may be provided for any type of vitality event. For instance, characteristic 304c indicates that a checked prioritization action is to be performed whenever a vitality event contains the word “rated”. However, if characteristic 304c were to include a drop-down (or equivalent) menu, the user 108 may select among any of a variety of actions.

Characteristic 304d indicates that a checked prioritization action is to be performed whenever a vitality event contains a link to the movie “Rocky IV”, shown as the default choice. However, categorizing this link as a “movie” also allows a user to choose to perform a checked prioritization action whenever a vitality event contains any movie link so categorized. Such categorization can be accomplished by matching the link URL with known subdomains containing, in this case, movie-related content.

If any two or more characteristics 304 are checked, criteria 314 enable the user 108 to designate either an AND operation 314a (shown as the default choice) or an OR operation 314b to be performed with respect to the checked characteristics. The AND operation requires that all checked characteristics be present for execution of a checked prioritization action 306. The OR operation performs the checked prioritization action(s) if any one or more of the checked characteristics are present.

Check boxes 310a-310d enable the user 108 to specify any one or more of the listed attribute values associated with the vitality action “rated”. Each of the listed attribute values is a characteristic; however, attribute values 310 are additive and relate only to “rated,” and so are discussed separately from characteristics 304. For example, regardless whether the user 108 designates an AND operation 314a or an OR operation 314b, an OR operation is performed with respect to any two or more specified attribute values 310. For example, checking characteristic 304c and selecting the attribute values “three stars” 310c and “four stars” 310d indicates that a checked prioritization action is to be performed whenever a vitality event contains the word “rated” with an attribute value of “three stars” and/or “four stars”. In this example, a vitality event containing the word “rated” with merely one or more of the attribute values “one star” or “two stars” does not satisfy the specified condition. Additionally, with lists of additive attributes, at least one attribute must be checked, and so “four stars” is designated as the initial default in this example. Thereafter, it is not permitted to uncheck all of the attributes, and in this case, unchecking characteristic 304c accomplishes the equivalent.

The user 108 may specify any one or more of the listed prioritization actions 306 by checking the box to the left of each respective action. Prioritization action 306a changes how a qualifying vitality event (i.e., a vitality event having the checked characteristic(s)) is to be displayed to the user 108 in vitality stream 202. The user 108 can choose either the default display mode setting 308a, which indicates not to display the qualifying vitality event text, or display mode setting 308b, which indicates to emphasize the text of the qualifying vitality event.

The “emphasize” display mode text settings 316a-316f are additive and relate only to “emphasize,” and so are discussed separately from prioritization actions 306. Settings 316a-316f involve emphasizing the vitality event text in the user's vitality stream 202 in some manner. For example, text setting 306a (the default value, since at least one of the text settings 316 must be checked when “emphasize” display mode setting 308b is chosen) causes the qualifying vitality event text to be displayed in bold font in the user's vitality stream 202. Text setting 316b causes the qualifying vitality event text to be italicized in the user's vitality stream 202. Text setting 316c causes the qualifying vitality event text to be underlined in the user's vitality stream 202. Text setting 316d causes the qualifying vitality event text to be displayed in colored font in the user's vitality stream 202. Text setting 316e causes the qualifying vitality event text to be displayed in large font in the user's vitality stream 202. Text setting 316h causes the qualifying vitality event text to be highlighted in the user's vitality stream 202. For text settings 316d and 316f, respective font and highlight colors can be specified through respective pop-up, drop-down, or equivalent menus, or other graphical interface elements that enable the user 108 to select colors. For text setting 316e, font size can be specified through a drop-down (or equivalent) menu or a numerical entry field.

Prioritization action 306b causes a qualifying vitality event to be archived in a list other than John's vitality stream. For example, the vitality event may be accessible in the list for up to <k> hours, days, weeks, etc. In another example, the vitality event may be archived indefinitely or for a designated period of time, and for up to a cumulative <m> megabytes for all vitality events in the list. In yet another example, the list may have a maximum of <n> vitality events that, when exceeded, causes the oldest vitality event to be deleted from the list.

In an aspect, prioritization action 306b may enable the user 108 to choose from among a plurality of archive lists. For instance, prioritization action 306b may be associated with a plurality of characteristics, each of which corresponds to a respective list. The user 108 may check one or more of the characteristics to cause a qualifying event to be archived in the respective one or more lists. Alternatively, prioritization action 306b may include a drop-down (or equivalent) menu to facilitate selection among the plurality of lists.

Priority designation module 102 may be configured to archive the entire vitality associated with a vitality event, including the vitality event itself and the content associated with any links included in the vitality event. Alternatively, priority designation module 102 may be configured to archive only the vitality entry itself. Menu 302 may give the user 108 an option between these alternatives.

Prioritization actions 306c-306e involve sending a message to the user 108 by email, instant message (“IM”), or short message service (“SMS”), respectively. The message may be sent to the user 108 in addition to adding the vitality event to the user's vitality stream 202. Alternatively, the message may be sent to the user 108 in lieu of adding the vitality event to the user's vitality stream 202, accomplished by choosing prioritization action 306a with display mode 308a in tandem with one or more messaging prioritization actions 306c-306e. Messaging prioritization actions 306c-306e require the user 108 to specify the recipient email address, userid and IM service, and phone number, respectively. In an aspect, the address, userid, and phone number can be entered into text fields. In another aspect, the IM service can be selected from a dropdown (or equivalent) menu that lists known IM services (e.g. Yahoo Messenger).

Prioritization actions 306a-306e are provided for illustrative purposes and are not intended to be limiting. For instance, fewer or more prioritization actions may be listed in graphical interface element 302. Moreover, graphical interface element 302 may include prioritization actions corresponding to other ways of emphasizing, de-emphasizing, archiving, messaging, etc. For example, messaging techniques other than those indicated by prioritization actions 306c-306e may be available to the user 108 through graphical interface element 302. Furthermore, although shown in the form of a menu in FIG. 3, graphical interface element 302 may be configured as any graphical interface that enables selection of characteristics, options, and prioritization actions for vitality events.

If the user 108 selects a vitality event for characterization that has the same combination of characteristics and prioritization actions as a previously characterized vitality event, priority designation module 102 may display graphical interface element 302 with any previously checked characteristic(s), prioritization action(s)and any associated value(s) (e.g. font color, email address, etc.) pre-selected. For example, priority designation module 102 may store the previously checked characteristic(s), prioritization action(s), and any associated value(s) in a database. When the user 108 selects the vitality event, priority designation module 102 may access the database to determine whether any characteristic(s), prioritization action(s), and associated value(s) in graphical interface element 302 are to be pre-selected. Any of the pre-selected characteristic(s),prioritization action(s), and associated value(s) can be re-specified by the user 108. Moreover, the user 108 may check and choose other characteristics and prioritization actions in graphical interface element 302. Priority designation module 102 may display graphical interface element 302 with an option that enables the user 108 to clear all of the pre-selected characteristic(s), prioritization action(s), and associated value(s).

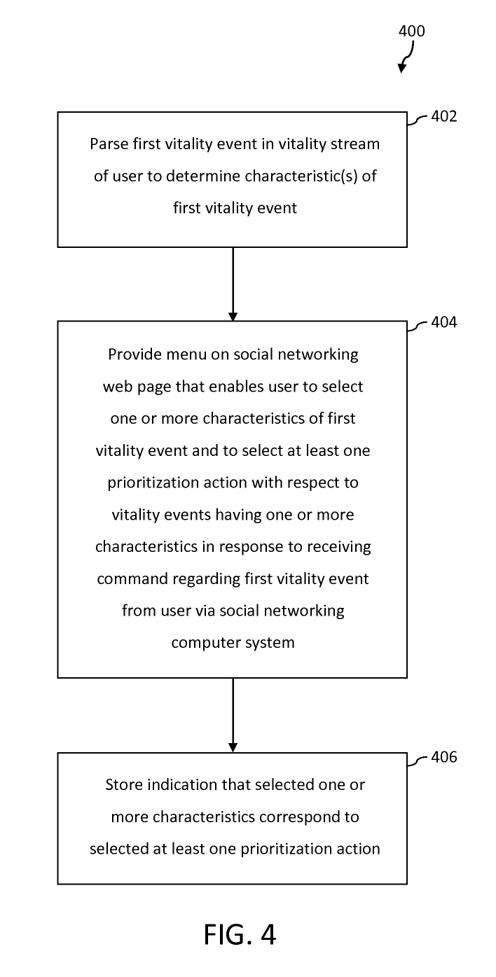

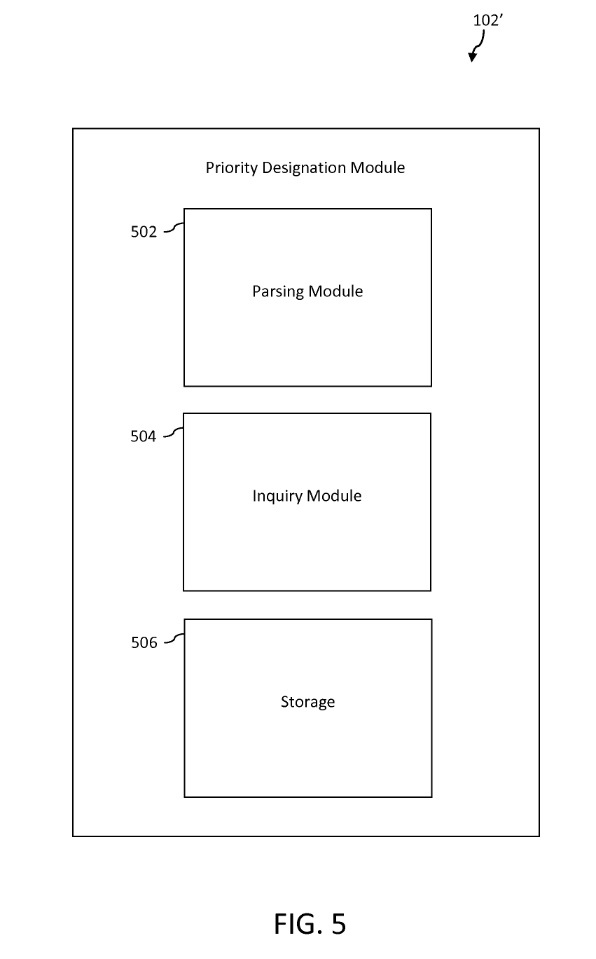

FIG. 4 shows a flowchart 400 of a method for characterizing a vitality event in accordance with an example embodiment of the present invention. Flowchart 400 may be performed by priority designation module 102 of social networking system 100 shown in FIG. 1, for example. For illustrative purposes, flowchart 400 is described with respect to a priority designation module 102′ shown in FIG. 5, which is an example of priority designation module 102, according to an embodiment of the present invention. As shown in FIG. 5, priority designation module 102′ includes a parsing module 502, an inquiry module 504, and a storage 506. Further structural and operational embodiments will be apparent to persons skilled in the relevant art(s) based on the discussion regarding flowchart 400. Flowchart 400 is described as follows.

As shown in FIG. 4, the method of flowchart 400 begins at step 402 in which parsing module 502 parses a first vitality event in a vitality stream of a user to determine characteristic(s) of the first vitality event. Example characteristics include but are not limited to a source value indicating a source of the first vitality event, a subject user item value, an action item value, an object item value, a non-subject user item value, or an attribute value of the first vitality event.

At strep 404, inquiry module 504 provides a graphical interface element, such as graphical interface element 302 of FIG. 3, on a social networking web page. The graphical interface element enables a user to select one or more characteristics of the first vitality event. The graphical interface element further enables the user to select at least one prioritization action with respect to vitality events having the one or more characteristics. The graphical interface element may show pre-selected characteristic(s), prioritization action(s), and any associated value(s) for any vitality event that has been previously characterized by the user. The graphical interface element may enable the user to de-select at least one of the pre-selected characteristic(s) and/or prioritization action(s) and/or change any associated value(s). Step 404 is performed in response to receiving a command regarding the first vitality event from the user via the social networking system.

In step 406, storage 506 stores an indication that the selected one or more characteristics correspond to the selected at least one prioritization action. For example, inquiry module 504 may receive a request for the indication from priority performance module 104 when priority performance module 104 receives a vitality event associated with the user. Inquiry module 504 may provide the indication to priority performance module 104 in response to receiving the request, so that the vitality event may be appropriately prioritized with respect to the user's vitality stream.

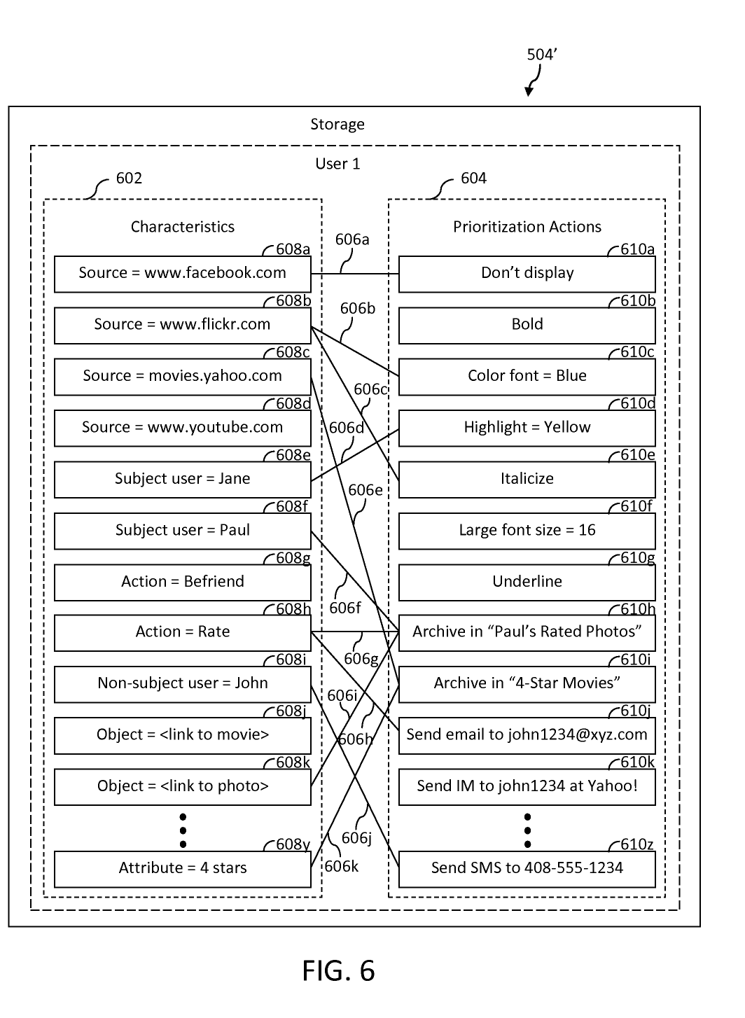

FIG. 6 is an example implementation 506′ of storage 506 shown in FIG. 5, according to an embodiment of the present invention. In FIG. 6, storage 506′ is shown to include characteristics database 602 and prioritization actions database 604 of user 1 for ease of discussion. It will be recognized by persons skilled in the relevant art(s), however, that storage 506′ may include a characteristics database and a prioritization actions database for each user in social network 106 who has established at least one priority designation.

Characteristics database 602 includes a listing of the characteristics 608a-608y for which user 1 has established a priority designation. Prioritization actions database 604 includes a listing of the prioritization actions 61Oa-610z for which user 1 has established a priority designation. Relationships between characteristics 608 and prioritization actions 610 (i.e., priority designations) are represented using lines 606, each of which connects a respective characteristic to a respective prioritization action.

For purposes of clarity, it will be assumed in the following discussion that multiple lines connecting a single characteristic to multiple respective prioritization actions indicate that each of the prioritization actions is to be performed with respect to a vitality event having the characteristic. Similarly, it will be assumed that multiple lines connecting respective characteristics to a single prioritization action indicate that the prioritization action is to be performed with respect to a vitality event having all of the respective characteristics. Accordingly, the multiple lines are indicative of an AND operation. It will be recognized that multiple lines may be indicative of other logical operations, such as an OR operation.

In FIG. 6, a first priority designation of user 1 is represented by line 606a, showing a relationship between characteristic 608a and prioritization action 610a. The first priority designation indicates that vitality events associated with user 1 that are provided by the source www.facebook.com are not to be displayed in the vitality stream of user 1.

A second priority designation of user 1 is represented by the lines 606b and 606c, showing a relationship between characteristic 608b and prioritization actions 610c and 610e. The second designation of user 1 indicates that vitality events associated with user 1 having the source www.flickr.com are to have a blue colored font and are to be italicized.

A third priority designation of user 1 is represented by line 606d

, showing a relationship between characteristic 608e and prioritization action 610d. The third designation of user 1 indicates that vitality events associated with user 1 for which Jane is the subject user are to be highlighted with yellow. In an aspect, priority designation module 102′ may not differentiate between subject users and non-subject users, in which case vitality events associated with user 1 for which Jane is the subject user or the non-subject user are to be highlighted.

A fourth priority designation of user 1 is represented by the lines 606e, 606h and 606k, showing a relationship between characteristics 608c, 606h, and 608y and prioritization action 610i. The fourth designation of user 1 indicates that vitality events associated with user 1 having the source movies.yahoo.com and the action “rate” with an attribute value of“four stars” are to be archived in a list entitled “4-Star Movies”.

A fifth priority designation of user 1 is represented by the lines 606f, 608g, and 608i, showing a relationship between characteristics 608f, 608h, and 608k and prioritization action 610h. The fifth designation of user 1 indicates that vitality events associated with user 1 for which Paul is the subject user, “rate” is the action, and a link to a photo is the object, are to be archived in a list entitled “Paul's Rated Photos”.

A sixth priority designation of user 1 is represented by the line 606j, showing a relationship between characteristic 608i and prioritization action 610z. The sixth designation of user 1 indicates that user 1 is to be notified by a short message service (SMS) message to phone number 408-555-1234 for any vitality event associated with user 1 for which John is the non-subject user.

The characteristics 608a-608y, prioritization actions 610a-610z, and priority designations shown in FIG. 6 are provided for illustrative purposes and are not intended to be limiting. For instance, characteristics database 602 and prioritization actions database 604 may include any suitable characteristic(s) and prioritization action(s), respectively, along with any corresponding associated value(s). The characteristics, prioritization actions, associated values, and corresponding relationships that are stored in storage 506′ will depend on the priority designations specified by the respective users in social network 106.

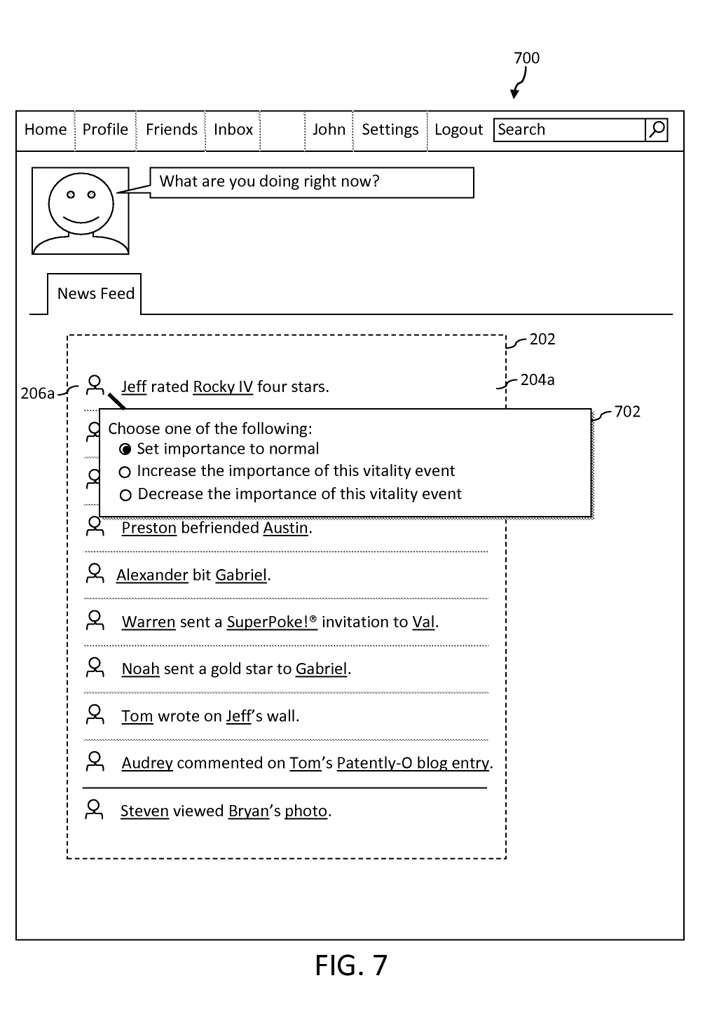

FIG. 7 is an illustration 700 of an example web page showing an inquiry 702 for characterizing a vitality event in accordance with an embodiment of the present invention. In particular, inquiry 702 enables a user to characterize a vitality event in the user's vitality stream 202 by changing weights associated with characteristics of the vitality event. As shown in FIG. 7, the user selects icon 206a corresponding to vitality event 204a in the user's vitality stream 202, causing inquiry 702 to be displayed in the web page. For example, priority designation module 102′ may generate inquiry 702 in response to the user selecting icon 206a.

Inquiry 702 enables the user to choose between increasing the weight of vitality event 204a and decreasing the weight of vitality event 204a. For example, if the user is particularly interested in vitality event 204a, the user may choose to increase the weight of vitality event 204a, causing priority designation module 102′ to increment the weight of each characteristic of vitality event 204a by a designated amount <w>. Thus, if <w>=1, the weight of each characteristic is incremented by one. It will be recognized that the variable <w> may be any value.

Assuming that the source of vitality event 204a is movies.yahoo.com for purposes of illustration, if the user chooses to increase the weight of vitality event 204a, all characteristics of vitality event 204a, including the source movies.yahoo.com, the user designated by “Jeff,” the action “rated”, the link to “Rocky IV”, and the rating attribute “four stars”, are incremented by <w>.

On the other hand, if the user is not interested in vitality event 204a, the user may choose to decrease the weight of vitality event 204a, causing priority designation module 102′ to decrement the weight of each characteristic of vitality event 204a by a designated amount <x>. If the user chooses to decrease the weight of vitality event 204a, all characteristics of vitality event 204a, including the source movies.yahoo.com, the user designated by “Jeff,” the action “rated”, the link to “Rocky IV”, and the rating attribute “four stars”, are decremented by <x>. For example, if <x>=2, the weight of each characteristic is decremented by two. It will be recognized that the variable <x> may be any value. Moreover, the variables <w> and <x> may be the same or different.

Although shown in the form of checkboxes in FIG. 7, inquiry 702 may include any type of graphical interface elements that enable users to increase and decrease weights.

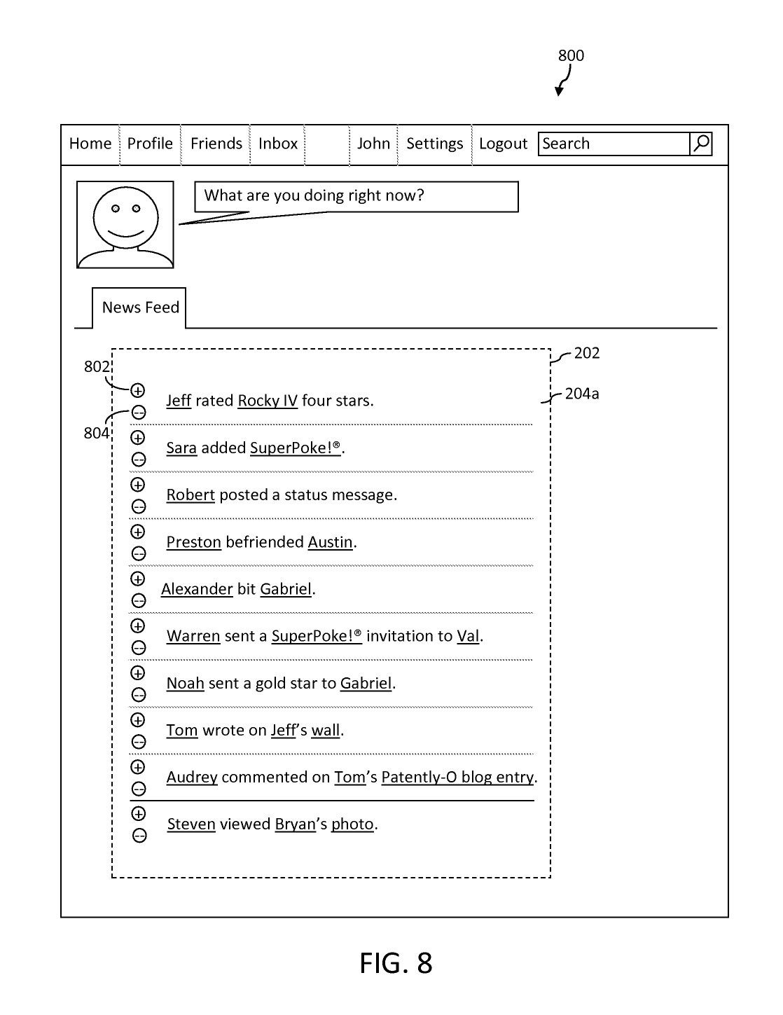

For instance, FIG. 8 is an illustration 800 of another example web page that enables a user to characterize a vitality event in the user's vitality stream 202 by changing weights associated with characteristics of the vitality event. Illustration 800 shows that separate icons may be used for increasing or decreasing the weight of each vitality event. As shown in FIG. 8, weight change icon 802 enables the user to increase the weight of vitality event 204a. For instance, the user may select icon 802 to cause priority designation module 102′ to increment the weight of each characteristic of vitality event 204a by a designated amount <w>. Weight change icon 804, on the other hand, enables the user to decrease the weight of vitality event 204a. For instance, the user may select icon 804 to cause priority designation module 102′ to decrement the weight of each characteristic of vitality event 204a by a designated amount <x>. Icons 802 and 804 may be visible at all times or only when the cursor is placed over them.

In yet another embodiment, the user may perform an implicit operation (e.g., clicking on a user or object link) to increase the weights of the respective characteristics of the vitality event by a designated amount <w>. The user may close a vitality event (effectively removing it from the vitality stream display) by clicking on a close icon, such as an “x” in the upper-right corner of the vitality event (as is customarily used to close items and windows) in the user's vitality stream 202, to decrease the weights of respective characteristics of the vitality event by a designated amount <w>. In this embodiment, only the close icon is needed to change the weights of a vitality event's characteristics.

Regardless which technique is used to change the weight of a vitality event, if the weight of any one or more of the characteristics in the vitality event reaches a respective threshold, the user is provided an opportunity to designate at least one prioritization action to be performed with respect to vitality events having any one or more of the characteristic(s) that reach the respective threshold(s).

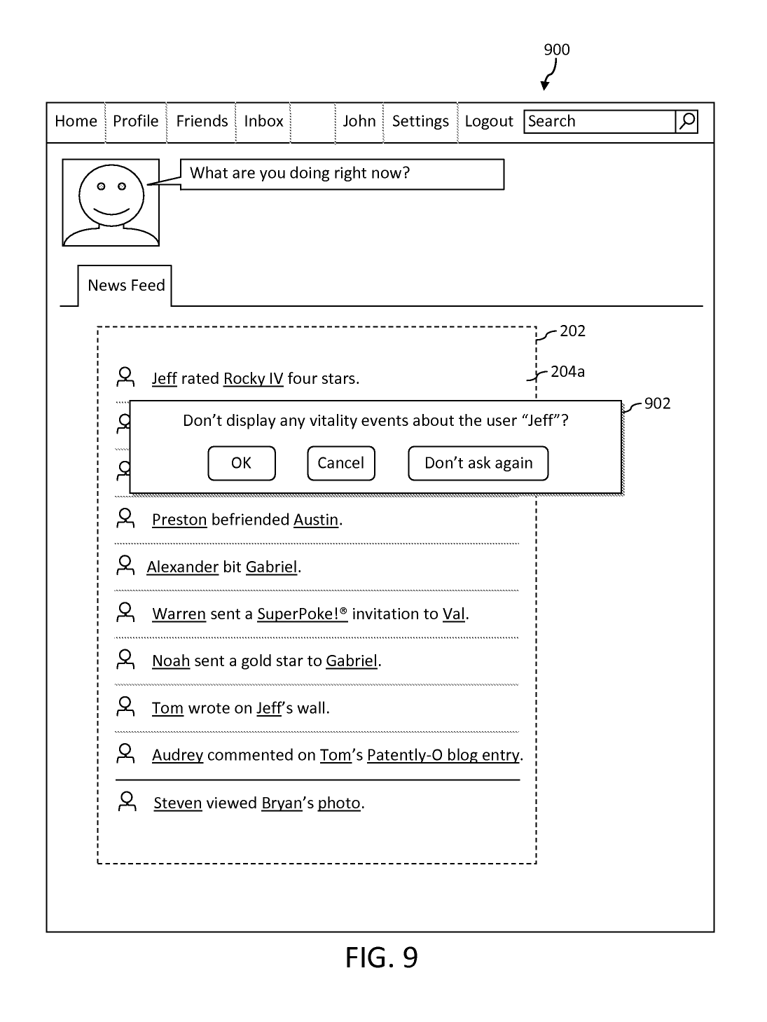

FIG. 9 is an illustration 900 of an example web page showing an inquiry 902 for designating a prioritization action as a result of the weight of a vitality event characteristic reaching a lower threshold, according to an embodiment of the present invention. As depicted in FIG. 9, the user decreased the weight of vitality event 204a, causing the characteristic “Jeff” to reach a lower threshold. In response to the lower threshold being reached, priority designation module 102′ provides inquiry 902, enabling the user to designate that any vitality events about the user “Jeff” are not to be displayed in the user's vitality stream 202.

In this example, the user may select “OK” to cause the specified prioritization action to be performed with respect to vitality events about the user “Jeff”. The user may select “Cancel” to refrain from making the priority designation, though priority designation module 102′ will present inquiry 902 to the user again if the user subsequently decreases the weight of a vitality event about the user “Jeff”. For example, priority designation module 102′ will again detect that the weight of the characteristic “Jeff” has reached the threshold. The user may select “Don't ask again” to refrain from making the priority designation and to prevent priority designation module 102′ from presenting inquiry 902 to the user again if the user subsequently decreases the weight of a vitality event about the user “Jeff”. For example, priority designation module 102′ may flag the characteristic “Jeff” so that the weight is not tested against the lower threshold.

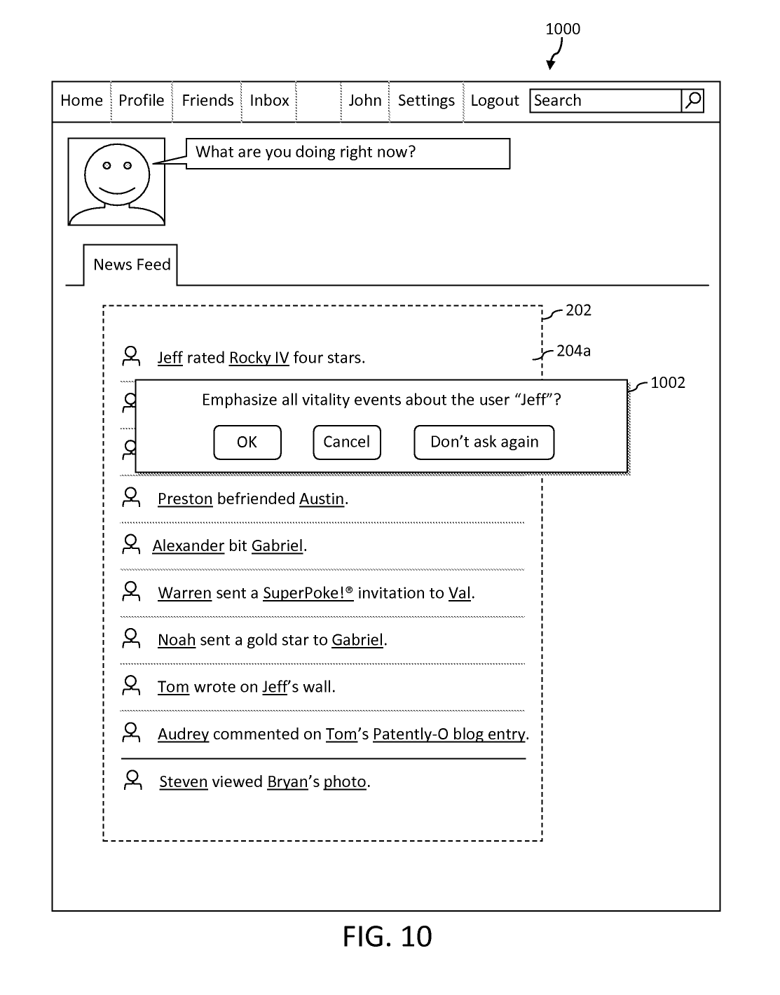

FIG. 10 is an illustration 1000 of an example web page showing an inquiry 1002 for designating a prioritization action as a result of the weight of a vitality event characteristic reaching an upper threshold, according to an embodiment of the present invention. As depicted in FIG. 10, the user increased the weight of vitality event 204a, causing the characteristic “Jeff” to reach an upper threshold. In response to the upper threshold being reached, priority designation module 102′ may provide inquiry 1002, enabling the user to designate that any vitality events about the user “Jeff” are to be emphasized in the user's vitality stream 202, via a user-specified or preset display mode. Alternatively, priority designation module 102′ may provide an inquiry, enabling the user to designate that any vitality events about the user “Jeff” are to be saved in a user-specified or preset archive list, or sent via a user-specified or preset messaging modality, or processed in accordance with some other prioritization action(s).The user may select “OK” to cause the specified prioritization action to be performed with respect to vitality events about the user “Jeff”. The user may select “Cancel” to refrain from making the priority designation, though priority designation module 102′ will present inquiry 902 to the user again if the user subsequently increases the weight of a vitality event about the user “Jeff”. The user may select “Don't ask again” to refrain from making the priority designation and to prevent priority designation module 102′ from presenting inquiry 902 to the user again if the user subsequently increases the weight of a vitality event that contains the word “Jeff”. For instance, priority designation module 102′ may flag the characteristic “Jeff” so that the weight is not tested against the upper threshold.

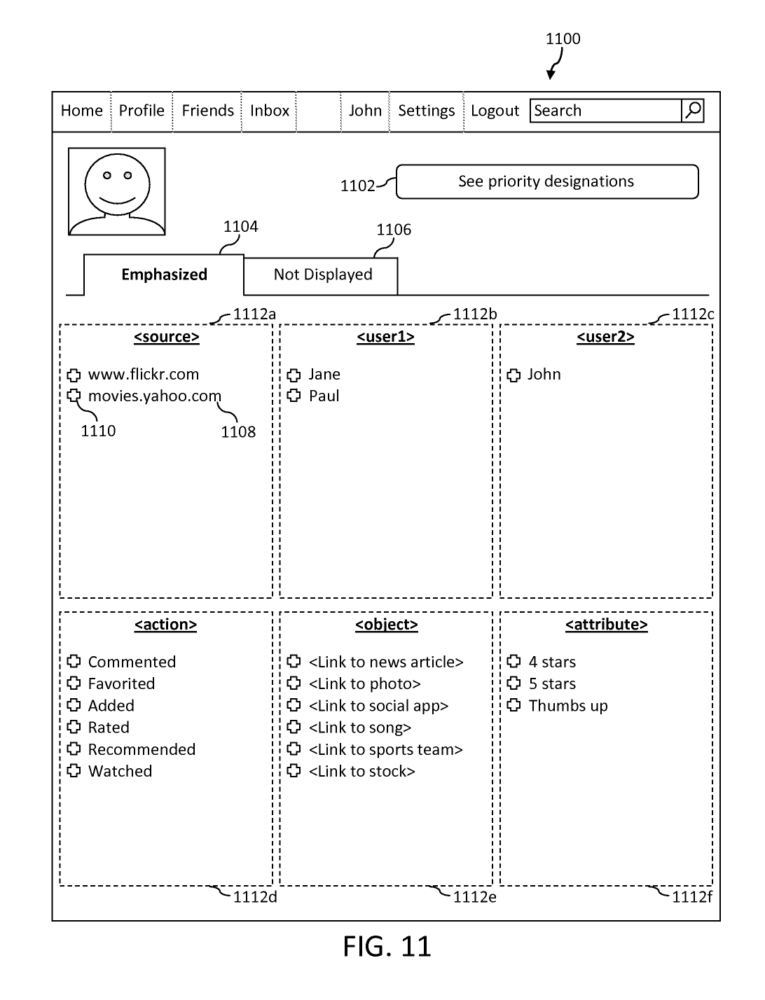

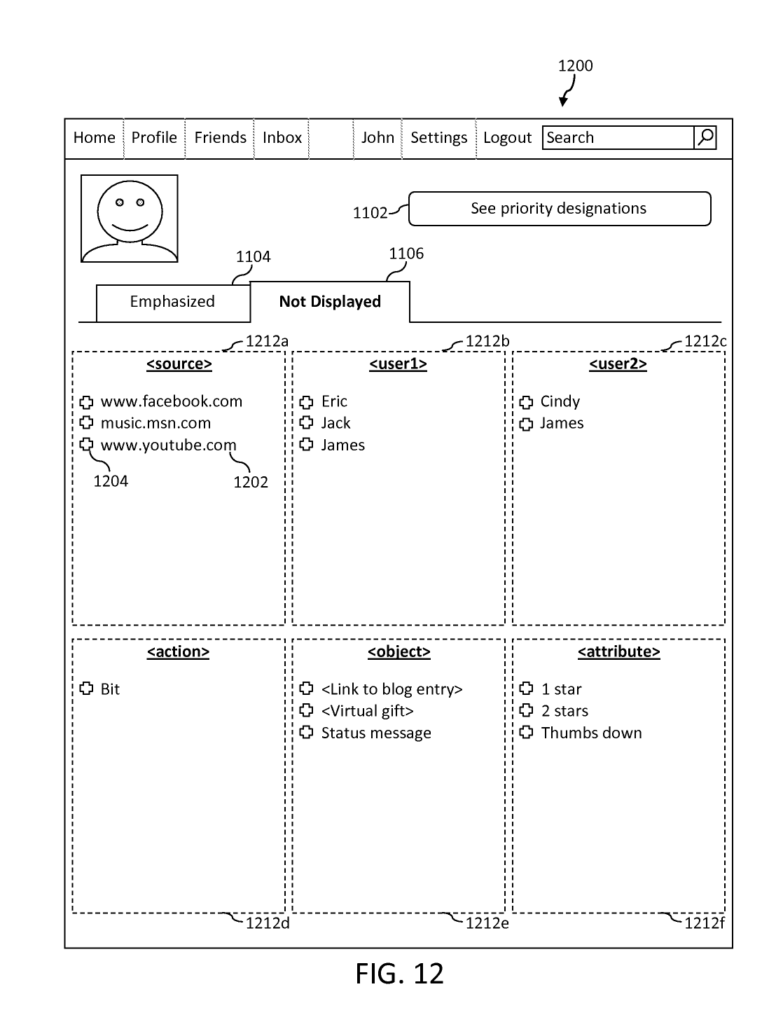

FIGS. 11-12 are illustrations 1100, 1200 of example web pages that enable a user to deselect a priority designation, according to embodiments of the present invention. For example, the web pages enable the user to deselect any one or more characteristics for which the user has designated a prioritization action. The user may select (e.g., click on) button 1102 to see the user's priority designations, which are categorized by prioritization action using tabs 1104 and 1106. As shown in FIG. 11, the user may select tab 1104 to cause priority designation module 102′ to list the characteristics for which vitality events are to be emphasized. For example, the user may have previously established the priority designations relating to tab 1104 in accordance with the techniques described above with reference to FIG. 10.

The characteristics relating to tab 1104 are referred to using reference pointer 1108. In an embodiment, if tab 1104 is selected, a graphical window is displayed that is segmented into a plurality of panes 1112a-1112f, with each pane displaying a corresponding type of vitality event item. Each pane 1112 lists one or more characteristics 1108. In FIG. 11, characteristics 1108 are categorized by six types—<source>, <user1>, <user2>, <action>, <object>, and <attribute>, and thus six panes 1112a-1112f are present. The characteristics corresponding to each respective type are alphabetized for illustrative purposes.

Each characteristic 1108 has a corresponding reset icon 1110, which the user may select to delete the corresponding characteristic from the list. For instance, in FIG. 11, pane 1112a lists www.flickr.com and movies.yahoo.com as first and second characteristics 1108 in the <source> category. Because they are listed under tab 1104, when www.flickr.com or movies.yahoo.com are present as a <source> of a vitality event, the vitality event is emphasized. If the user selects the reset icon 1110 corresponding to the characteristic movies.yahoo.com, priority designation module 102′ deletes movies.yahoo.com from the list in pane 1112a and resets the weight of the characteristic movies.yahoo.com to zero.

The <user1> and <user2> categories 1112b, 1112c are represented separately in FIG. 11 for illustrative purposes, though persons skilled in the relevant art(s) will recognize that these categories may be combined into a common <user> category, including the values for both <user1> and <user2> items.

Characteristics 1108 in the <object> category 1112e correspond to a variety of respective link types. For example, the characteristic <Link to news article> corresponds to any news article content. Priority designation module 102′ may maintain a list of uniform resource locators (URLs) (or similar identifiers) of news providers and compare the URL in any link of a vitality event to the list of news provider URLs to determine whether the link pertains to a news article. In another example, the characteristic <link to photo> corresponds to any photo. Priority designation module 102′ may maintain a list of file extensions applicable to photos (e.g., BMP, GIF, JPEG, TIFF, etc.) and compare the file extension in any link of a vitality event to the list of photo file extensions to determine whether the link pertains to a photo. Similar techniques may be used to determine whether a link pertains to other types of content, such as those listed in FIG. 11.

Persons skilled in the relevant art(s) will recognize that characteristics, such as those shown in pane 1112e, may include links to specific content. For instance, a characteristic may include a URL for a particular news article, blog entry, photo, video, etc.

It should be noted that the graphical window in illustration 1100 need not necessarily include panes corresponding to all six respective types of characteristics depicted in FIG. 11. For instance, any two or more of the categories may be combined in a single pane, and/or one or more of the categories may not be included in the graphical window. For panes corresponding to a combination of categories, weights may be assigned to the respective combined entities (e.g., “<user><action>,” “<action><object>”, etc., where the items in each combined entity are combined using a logical AND operation). Hence, the items in a combined entity do not have separate respective weights. In one example, the <action> and <object> categories may be combined in a single pane, so that each combination of an action and an object has a corresponding reset icon 1110. In another example, the <object> and <attribute> categories may be combined in a single pane. In yet another example, the <user> and <action> categories may be combined in a single pane. In still another example, the <attribute> category may not be represented in any of the panes in the graphical window.

As shown in FIG. 12, the user may select tab 1106 to cause priority designation module 102′ to list the characteristics for which vitality events are not to be diplayed in the user's vitality stream. In an embodiment, similarly to tab 1104 described above with respect to FIG. 11, if tab 1106 is selected, a graphical window is displayed that is segmented into a plurality of panes 1212a-1212f, with each pane listing characteristics for a corresponding type of vitality event. For example, the user may have previously established the priority designations relating to tab 1106 in accordance with the techniques describe above with reference to FIG. 9.

The characteristics relating to tab 1106 are referred to using reference pointer 1202. Each characteristic 1202 has a corresponding reset icon 1204, which the user may select to delete the corresponding characteristic from the list. For instance, if the user selects the reset icon 1204 corresponding to the characteristic www.youtube.com, priority designation module 102′ deletes www.youtube.com from the list in pane 1212a and resets the weight of the characteristic www.youtube.com to zero.

In FIG. 12, the characteristic <Link to blog entry> pertains to any blog entry, and the characteristic <Virtual gift> pertains to any virtual gift (e.g., gold star, friendship bracelet, etc.). It will be recognized, however, that characteristics may include links to specific content.

Note that FIGS. 11-12 are provided for illustrative purposes, and that characteristics pertaining to tabs 1104 and 1106 may be present in alternative ways. For example, in one aspect, characteristics pertaining to respective tabs 1104 and 1106 may be concurrently shown on the web page. For instance, the characteristics pertaining to the respective tabs 1104 and 1106 may concurrently occupy respective portions of the web page. In another aspect, the user may select a respective characteristic type heading, causing priority designation module 102′ to list the characteristics pertaining to that heading on a dedicated web page. For example, the characteristics pertaining to the heading may be too numerous to be shown in the example format provided in FIGS. 11 and 12. Dedicating a web page to those characteristics may enable the user to view all such characteristics.

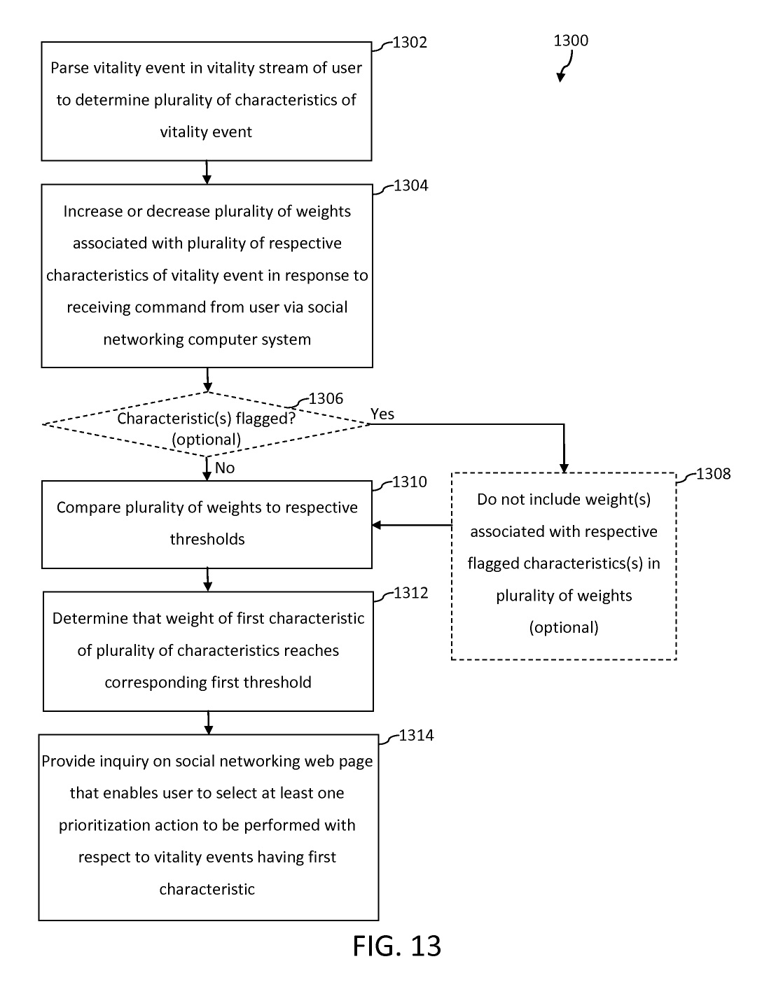

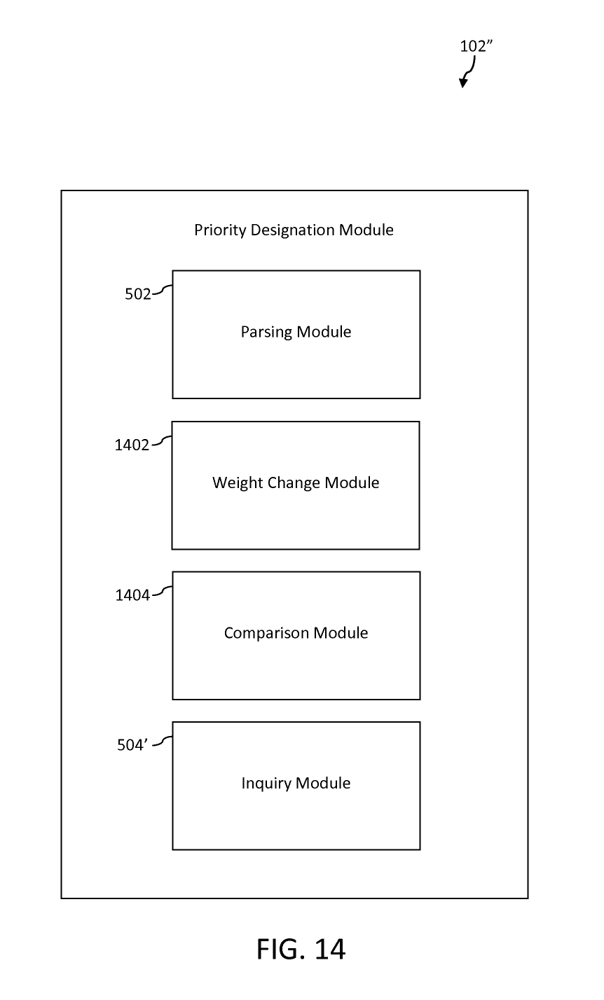

FIG. 13 shows a flowchart 1300 of a method for characterizing a vitality event in accordance with another example embodiment of the present invention. Flowchart 1300 may be performed by priority designation module 102 of social networking system 100 shown in FIG. 1, for example. For illustrative purposes, flowchart 1300 is described with respect to a priority designation module 102″ shown in FIG. 14, which is an example of priority designation module 102, according to an embodiment of the present invention. As shown in FIG. 14, priority designation module 102″ includes a weight change module 1402, a comparison module 1404, and an inquiry module 504′. Further structural and operational embodiments will be apparent to persons skilled in the relevant art(s) based on the discussion regarding flowchart 1300. Flowchart 1300 is described as follows.

As shown in FIG. 13, the method of flowchart 1300 begins at step 1302 in which parsing module 502 parses a vitality event in a vitality stream of a user to determine a plurality of characteristics of the vitality event. At step 1304, weight change module 1402 increases or decreases a plurality of weights associated with the plurality of respective characteristics of the vitality event. The plurality of weights are increased or decreased in response to inquiry module 504′ receiving a command from the user via the social networking computer system. For instance, the user may generate the command by selecting an icon, such as icon 206a, 802, or 804, associated with vitality event 204a in the user's vitality stream 202.

At step 1306, comparison module 1404 determines whether one or more of the plurality of characteristics is flagged by the user for preventing the weight of the flagged characteristic(s) from being tested against corresponding threshold(s). If comparison module 1404 determines that none of the plurality of characteristics is flagged, flow continues to step 1310. However, if comparison module 1404 determines that one or more of the plurality of characteristics is flagged, comparison module 1404 removes one or more weights associated with the respective one or more characteristics from the plurality of weights at step 1308. It should be noted that steps 1306 and 1308 are optional. For instance, in an embodiment, flow may continue directly from step 1304 to step 1310.

At step 1310, comparison module 1404 compares the plurality of weights to respective thresholds. For example, if the plurality of weights are increased at step 1304, the plurality of weights are compared to respective upper thresholds at step 1310. Alternatively, if the plurality of weights are decreased at step 1304, the plurality of weights are compared to respective lower thresholds at step 1310. The respective thresholds may be different or the same.

At step 1312, comparison module 1404 determines that a weight of a first characteristic of the plurality of characteristics reaches a corresponding first threshold.

At step 1314, inquiry module 504′ provides an inquiry, such as inquiry 902 or 1002, on a social networking web page that enables the user to select at least one prioritization action to be performed with respect to vitality events having the first characteristic at step 1314. For instance, if the weight of the first characteristic reaches a lower threshold at step 1312, a first inquiry, such as inquiry 902, is provided to (e.g., displayed at) the user's social networking web page. Alternatively, if the weight of the first characteristic reaches an upper threshold at step 1312, a second inquiry, such as inquiry 1002, is provided to the user's social networking web page.

Weight change module 1402 may enable the user to flag the first characteristic so that the weight of the first characteristic is not tested against the first threshold. For instance, if the user flags the first characteristic, any prioritization action selected by the user in step 1314 are discontinued with respect to vitality events having the first characteristic. Inquiry module 504′ may provide a listing on the social networking web page that includes one or more lists associated with respective one or more user-selected prioritization actions, such as the actions identified by tabs 1104 and 1106 in FIGS. 11-12. Inquiry module 504′ may further enable the user to delete a characteristic from a list in the listing.

### V. Example Priority Performance Embodiments

Example embodiments are described in this section for performing user-specified prioritization actions. Embodiments are described for performing prioritization actions with respect to vitality events associated with a user based on priority designations established by the user. The example embodiments described herein are provided for illustrative purposes, and are not limiting. Further structural and operational embodiments, including modifications/alterations, will become apparent to persons skilled in the relevant art(s) from the teachings herein.

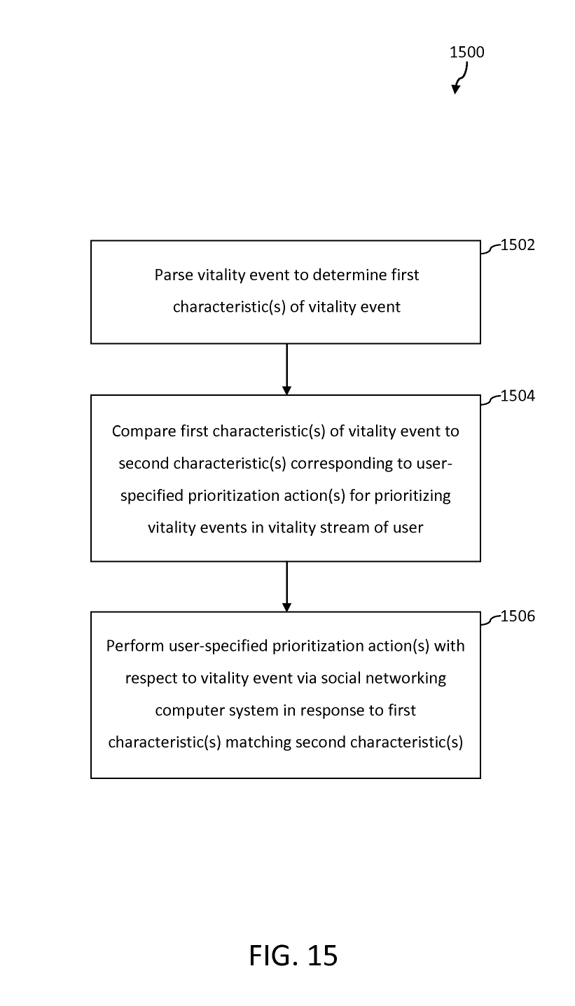

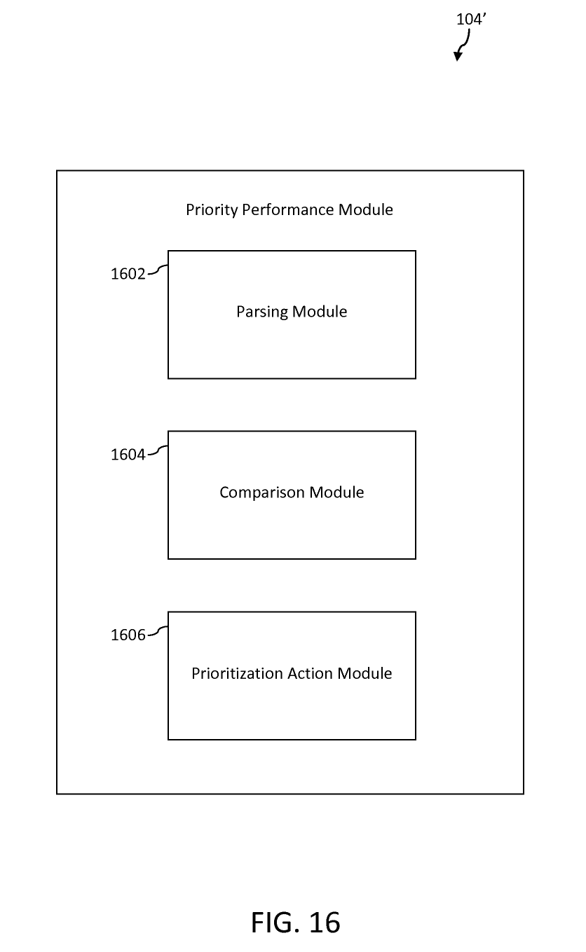

FIG. 15 shows a flowchart 1500 of a method for performing prioritization action(s) in accordance with an example embodiment of the present invention. Flowchart 1500 may be performed by priority performance module 104 of social networking system 100 shown in FIG. 1, for example. For illustrative purposes, flowchart 1500 is described with respect to a priority performance module 104′ shown in FIG. 16, which is an example of priority performance module 104, according to an embodiment of the present invention. As shown in FIG. 16, priority performance module 104′ includes a parsing module 1602, a comparison module 1604, and a prioritization action module 1606. Further structural and operational embodiments will be apparent to persons skilled in the relevant art(s) based on the discussion regarding flowchart 1500. Flowchart 1500 is described as follows.

As shown in FIG. 15, the method of flowchart 1500 begins at step 1502 in which parsing module 1602 parses a vitality event to determine a first characteristic(s) of the vitality event. For example, the vitality event may be configured in accordance with a syntax as described above in section III. Each source in social network 106 may generate vitality events in accordance with a designated syntax associated with the respective source. Parsing module 1602 may include a database for storing a list that cross-references sources with their respective syntaxes. For example, the database may include templates associated with respective sources. Parsing module 1602 may access the database to determine the syntax corresponding to a source of a received vitality event to facilitate parsing of the vitality event.

Alternatively, parsing module 1602 may parse the vitality event in accordance with a natural language technique. Numerous natural language parsing techniques are known to persons skilled in the relevant art(s).

In step 1504, comparison module 1604 compares the first characteristic(s) of the vitality event to a second characteristic(s) corresponding to user-specified prioritization action(s) for prioritizing vitality events in a vitality stream of the user. For instance, comparison module 1604 may receive priority designations associated with the user from priority designation module 102. Comparison module 1604 may compare the characteristics in the user's priority designations to the first characteristic(s) of the vitality event to determine whether the characteristic(s) matches a second characteristic(s) associated with a priority designation of the user.

In step 1506, prioritization action module 1606 performs the user-specified prioritization action(s) with respect to the vitality event via the social networking computer system in response to the first characteristic(s) matching the second characteristic(s). For example, comparison module 1604 may indicate to prioritization action module 1606 that a second characteristic(s) associated with a priority designation of the user matches the characteristic(s) of the vitality event. Prioritization action module 1606 may perform the user-specified prioritization action(s) in response to receiving the indication from comparison module 1604. For example, the user-specified prioritization action(s) may be associated with the priority designation that is associated with the second characteristic(s).

The characteristic(s) of the vitality event may include any number and/or type of characteristics. For example, the characteristic(s) may include a characteristic indicative of a source of the vitality event, a syntax of the vitality event, one or more values of items in the vitality event, etc.

Prioritization action module 1606 may perform any of a variety of prioritization actions, such as not displaying the vitality event in the vitality stream of the user, messaging the user in some manner to indicate receipt of the vitality event, archiving the vitality event, etc.

It should be noted that the user may manipulate vitality events in the vitality stream and/or archive lists of the user. For example, the user may delete one or more vitality events from the stream or list. The user may reorder vitality events in the stream or list (e.g., move a vitality event up or down the list). The user may sort vitality events (e.g., by <date> (default), <source>, <user>, <action>, or <object>). The user may send a vitality event to another user within social network 106 via any messaging modalities that are supported by social networking system 106. The user may share a vitality event with a person outside social network 106 (e.g., by email, IM, SMS, etc.). The user may create an RSS feed to which others may subscribe via a reader, such as found on my.yahoo.com or other web sites. The user may configure the vitality stream, list, RSS feed, etc. to be private or public. For instance, the user may configure the stream, list, RSS feed, etc. to be available on the user's home or profile web page.

The embodiments described herein have a variety of benefits as compared to conventional social networking systems. For example, embodiments enable a user to not display specified vitality events in the user's vitality stream, emphasize specified vitality events in the user's vitality stream, archive specified vitality events, and/or send a message (e.g., email, IM, SMS, etc.) to the user when a specified vitality event is received. If the user chooses to archive a vitality event, the vitality event may be accessed at any time at the leisure of the user. If the user chooses to receive a message upon receipt of a vitality event, the user need not necessarily wait to see the vitality event fortuitously upon logging into the social networking system.

### VI. Example Computer System Implementation

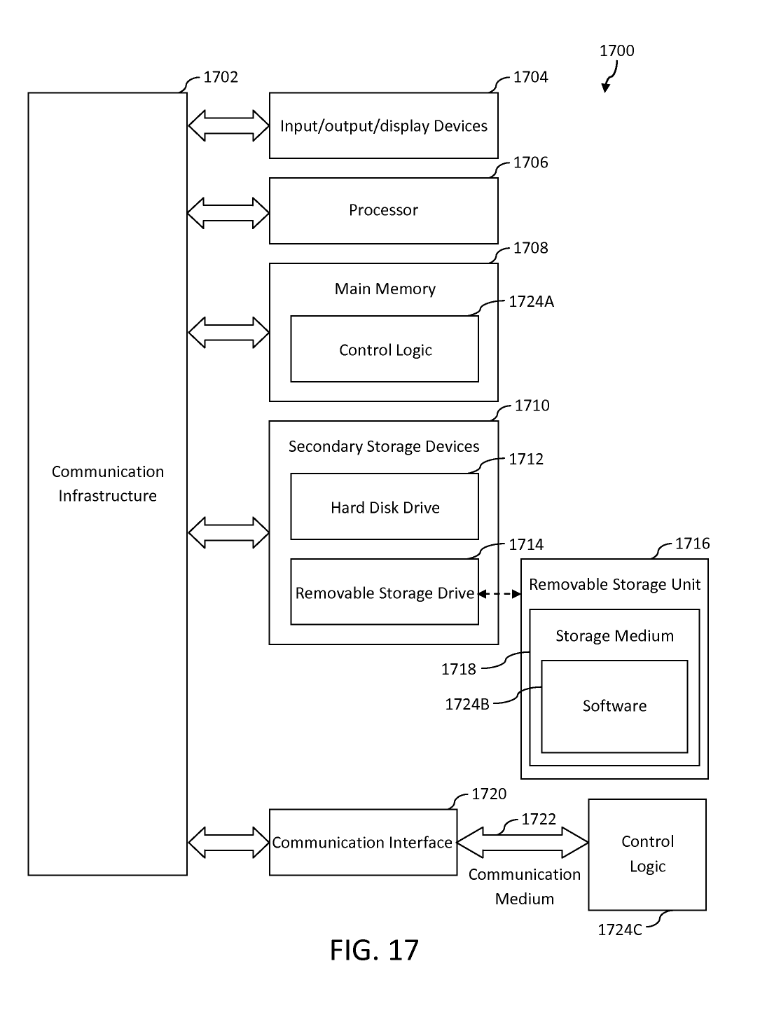

The embodiments described herein, including systems, methods/processes, and/or apparatuses, may be implemented using well-known servers/computers, such as computer 1700 shown in FIG. 17. For example, elements of example social networking system 100, including priority designation module 102 depicted in FIGS. 1, 5, and 14 and priority performance module 104 depicted in FIGS. 1 and 16, and each of the steps of flowcharts 400, 1300, and 1500 depicted in respective FIGS. 4, 13, and 15, can each be implemented using one or more computers 1700.

Computer 1700 can be any commercially available and well known computer capable of performing the functions described herein, such as computers available from International Business Machines, Apple, Sun, HP, Dell, Cray, etc. Computer 1700 may be any type of computer, including a desktop computer, a server, etc.

As shown in FIG. 17, computer 1700 includes one or more processors (e.g., central processing units (CPUs)), such as processor 1706. Processor 1706 may include parsing module 502 of FIGS. 5 and 14, inquiry module 504 of FIGS. 5 and 14, weight change module 1402 of FIG. 14, comparison module of FIG. 14, parsing module 1602 of FIG. 16, comparison module 1604 of FIG. 16, or prioritization action module 1606 of FIG. 16, or any portion or combination thereof, for example, though the scope of the embodiments is not limited in this respect. Processor 1706 is connected to a communication infrastructure 1702, such as a communication bus. In some embodiments, processor 1706 can simultaneously operate multiple computing threads.

Computer 1700 also includes a primary or main memory 1708, such as a random access memory (RAM). Main memory has stored therein control logic 1724A (computer software), and data.

Computer 1700 also includes one or more secondary storage devices 1710. Secondary storage devices 1710 include, for example, a hard disk drive 1712 and/or a removable storage device or drive 1714, as well as other types of storage devices, such as memory cards and memory sticks. For instance, computer 1700 may include an industry standard interface, such as a universal serial bus (USB) interface for interfacing with devices such as a memory stick. Removable storage drive 1714 represents a floppy disk drive, a magnetic tape drive, a compact disk drive, an optical storage device, tape backup, etc.

Removable storage drive 1714 interacts with a removable storage unit 1716. Removable storage unit 1716 includes a computer useable or readable storage medium 1718 having stored therein computer software 1724B (control logic) and/or data. Removable storage unit 1716 represents a floppy disk, magnetic tape, compact disc (CD), digital versatile disc (DVD), Blue-ray disc, optical storage disk, memory stick, memory card, or any other computer data storage device. Removable storage drive 1714 reads from and/or writes to removable storage unit 1716 in a well-known manner.

It will be apparent to persons skilled in the relevant art(s) that storage 506 of FIGS. 5-6 may be included in main memory 1708, secondary memory 1710, removable storage unit 1716, or some combination thereof, though the scope of the embodiments is not limited in this respect.

Computer 1700 also includes input/output/display devices 1704, such as monitors, keyboards, pointing devices, etc.

Computer 1700 further includes a communication or network interface 1720. Communication interface 1720 enables computer 1700 to communicate with remote devices. For example, communication interface 1720 allows computer 1700 to communicate over communication networks or mediums 1722 (representing a form of a computer useable or readable medium), such as local area networks (LANs), wide area networks (WANs), the Internet, etc. Network interface 1720 may interface with remote sites or networks via wired or wireless connections. Examples of communication interface 1722 include but are not limited to a modem, a network interface card (e.g., an Ethernet card), a communication port, a Personal Computer Memory Card International Association (PCMCIA) card, etc.

Control logic 1724C may be transmitted to and from computer 1700 via the communication medium 1722.

Any apparatus or manufacture comprising a computer useable or readable medium having control logic (software) stored therein is referred to herein as a computer program product or program storage device. This includes, but is not limited to, computer 1700, main memory 1708, secondary storage devices 1710, and removable storage unit 1716. Such computer program products, having control logic stored therein that, when executed by one or more data processing devices, cause such data processing devices to operate as described herein, represent embodiments of the invention.

For example, each of the elements of example social networking system 100, including priority designation module 102 depicted in FIGS. 1, 5, and 14 and priority performance module 104 depicted in FIGS. 1 and 16, their sub-elements, and each of the steps of flowcharts 400, 1300, and 1500 depicted in respective FIGS. 4, 13, and 15 can be implemented as control logic that may be stored on a computer useable medium or computer readable medium, which can be executed by one or more processors to operate as described herein.

The invention can be put into practice using with software, hardware, and/or operating system implementations other than those described herein. Any software, hardware, and operating system implementations suitable for performing the functions described herein can be used.

### VII. Conclusion

While various embodiments of the present invention have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of prioritizing vitality events in a social networking computer system, the method comprising:
parsing a vitality event in a vitality stream of a user to determine a plurality of characteristics of the vitality event;
increasing or decreasing a plurality of weights associated with the plurality of respective characteristics in response to receiving a first command from the user via the social networking computer system;
comparing the plurality of weights to respective thresholds;
determining that a weight of a first characteristic of the plurality of characteristics reaches a corresponding first threshold; and
in response to the determining step, providing an inquiry on a social networking web page that enables the user to select at least one prioritization action to be performed with respect to vitality events having the first characteristic.

2. The method of claim 1, wherein providing the inquiry includes providing the inquiry that enables the user to select a prioritization action that excludes the vitality events having the first characteristic from the vitality stream of the user.

3. The method of claim 1, wherein providing the inquiry includes providing the inquiry that enables the user to select a prioritization action that emphasizes the vitality events having the first characteristic in the vitality stream of the user.

4. The method of claim 1, wherein providing the inquiry includes providing the inquiry that enables the user to select a prioritization action that archives the vitality events having the first characteristic.

5. The method of claim 1, wherein providing the inquiry includes providing the inquiry that enables the user to select a prioritization action that sends a message to the user indicating receipt of a vitality event having the first characteristic.

6. The method of claim 1, further comprising:
excluding one or more weights associated with respective one or more characteristics of the plurality of characteristics from the plurality of weights that are compared to the respective thresholds in response to a second command received from the user.

7. The method of claim 1, further comprising:
providing a listing on the social networking web page that includes one or more lists associated with respective one or more user-selected prioritization actions and each including at least one associated characteristic.

8. The method of claim 7, further comprising:
enabling the user to delete a characteristic from a list in the listing.

9. A computer program product comprising a computer-readable medium having computer program logic recorded thereon for enabling a processor-based system to prioritize vitality events in a social networking computer system, comprising:
a first program logic module for enabling the processor-based system to parse a vitality event in a vitality stream of a user to determine a plurality of characteristics of the vitality event;
a second program logic module for enabling the processor-based system to increase or decrease a plurality of weights associated with the plurality of respective characteristics in response to receiving a first command from the user;
a third program logic module for enabling the processor-based system to compare the plurality of weights to respective thresholds to determine that a weight of a first characteristic of the plurality of characteristics reaches a corresponding first threshold; and
a fourth program logic module for enabling the processor-based system to provide an inquiry on a social networking web page that enables the user to select at least one prioritization action to be performed with respect to vitality events having the first characteristic in response to the weight of the first characteristic reaching the corresponding first threshold.

10. The computer program product of claim 9, wherein the fourth program logic module includes instructions for enabling the processor-based system to provide the inquiry that enables the user to select a prioritization action that excludes the vitality events having the first characteristic from the vitality stream of the user.

11. The computer program product of claim 9, wherein the fourth program logic module includes instructions for enabling the processor-based system to provide the inquiry that enables the user to select a prioritization action that emphasizes the vitality events having the first characteristic in the vitality stream of the user.

12. The computer program product of claim 9, wherein the fourth program logic module includes instructions for enabling the processor-based system to provide the inquiry that enables the user to select a prioritization action that archives the vitality events having the first characteristic.

13. The computer program product of claim 9, wherein the fourth program logic module includes instructions for enabling the processor-based system to provide the inquiry that enables the user to select a prioritization action that sends a message to the user indicating receipt of a vitality event having the first characteristic.

14. The computer program product of claim 9, further comprising:
a fifth program logic module for enabling the user to exclude one or more weights associated with respective one or more characteristics of the plurality of characteristics from the plurality of weights that are compared to the respective thresholds in response to receiving a second command from the user.

15. The computer program product of claim 9, further comprising:
a fifth program logic module for enabling the processor-based system to provide a listing on the social networking web page that includes one or more lists associated with respective one or more user-selected prioritization actions and each including at least one associated characteristic.

16. The computer program product of claim 15, wherein the fifth program logic module includes instructions for enabling the user to delete a characteristic from a list in the listing.

17. A social networking priority designation system comprising:
a parsing module configured to parse a vitality event in a vitality stream of a user to determine a plurality of characteristics of the vitality event;
a weight change module configured to increase or decrease a plurality of weights associated with the plurality of respective characteristics in response to receiving a first command from the user via a social networking computer system;
a comparison module configured to compare the plurality of weights to respective thresholds to determine that a weight of a first characteristic of the plurality of characteristics reaches a corresponding first threshold; and
an inquiry module configured to provide an inquiry on a social networking web page that enables the user to select at least one prioritization action to be performed with respect to vitality events having the first characteristic in response to the weight of the first characteristic reaching the corresponding first threshold.

18. The system of claim 17, wherein the inquiry module is configured to provide the inquiry to enable the user to select a prioritization action that excludes the vitality events having the first characteristic from the vitality stream of the user.

19. The system of claim 17, wherein the inquiry module is configured to provide the inquiry to enable the user to select a prioritization action that emphasizes the vitality events having the first characteristic in the vitality stream of the user.

20. The system of claim 17, wherein the inquiry module is configured to provide the inquiry to enable the user to select a prioritization action that archives the vitality events having the first characteristic.
